(19) United States
(12) Patent Application Publication
(10) Pub. No.: US 2020/0160249 A1
(43) Pub. Date: May 21, 2020

(54) SYSTEMS, METHODS, AND APPARATUSES FOR WORKFORCE RESOURCE ANALYSIS AND WORKFORCE MANAGEMENT

(71) Applicant: APC Workforce Solutions, LLC, Orlando, FL (US)

(72) Inventors: Nancy Daniel Hecker, Orlando, FL (US); Mark Woytowicz Wyatt, Santa Rosa, CA (US)

(21) Appl. No.: 16/685,674

(22) Filed: Nov. 15, 2019

Related U.S. Application Data
(60) Provisional application No. 62/767,680, filed on Nov. 15, 2018.

(51) Int. Cl. G06Q 10/06; G06Q 10/10

(52) U.S. Cl. CPC G06Q 10/06398; G06Q 10/103; G06Q 10/105

(57) ABSTRACT

Systems, methods, and apparatuses are described for workforce resource analysis. First workforce resource project data associated with a job category and a first location may be determined. Second workforce resource project data associated with the job category and a second location may be determined. Based on the first workforce resource project data and the second workforce resource project data, a default markup rate associated with the job category and a third location may be determined. The third location may geographically encompass the first location and the third location.

### CROSS-REFERENCE TO RELATED APPLICATIONS

This application claims the benefit of U.S. Provisional Patent Application No. 62/767,680, filed on Nov. 15, 2018, entitled “Systems, Methods and Apparatuses For Workplace Resource Analysis,” the contents of which are hereby incorporated by reference herein in its entirety.

### BACKGROUND

In contingent workforce requisition, a hiring party may interact with one or more intermediaries (e.g., a contingent workforce “supplier”) to identify a workforce resource that meets the requirements of the hiring party. But the hiring party may face challenges in evaluating candidate workforce resources, as well as the terms imposed by any associated suppliers (e.g., a supplier's markup). As such, improvements are needed.

### SUMMARY

Systems, methods, and apparatuses are described for workforce resource analysis. In an example method, first workforce resource project data associated with a job category and a first location may be determined. Second workforce resource project data associated with the job category and a second location may be determined. Based on the first workforce resource project data and the second workforce resource project data, a default markup rate associated with the job category and a third location may be determined. The third location may geographically encompass or be the same or adjacent to one or more of the first location and the second location.

In an example method, a first one or more project records associated with a job category and a first location may be determined. Each project record of the first one or more project records is associated with a workforce requisition requested by a requesting party, facilitated by an intermediate party, and performed by a workforce resource party. Each project record of the first one or more project records indicates a workforce resource payment rate according to which the workforce resource party was paid for performing work associated with the workforce requisition and a workforce resource cost rate according to which the requesting party paid for the work performed by the workforce resource party. Based on the first one or more project records, a first default markup rate associated with the job category and the first location may be determined. A second one or more project records associated with the job category and a second location may be determined. Each project record of the second one or more project records may be associated with a workforce requisition requested by a requesting party, facilitated by an intermediate party, and performed by a workforce resource party. Each project record of the second one or more project records indicates a workforce resource payment rate according to which the workforce resource party was paid for performing work associated with the workforce requisition and a workforce resource cost rate according to which the requesting party paid for the work performed by the workforce resource party. Based on the second one or more project records, a second default markup rate associated with the job category and the second location may be determined. Based on the first default markup rate and the second default markup rate, a third default markup rate associated with the job category and a third location may be determined. The first location and the second location may be geographically encompassed, at least in part, by the third location.

In another example embodiment, a method may include determining, by a processor, a first one or more project records associated with a job category and a first location. Each project record of the first one or more project records may indicate a workforce resource payment rate for worked performance in relation to the job category and the first location. The method may further include determining, by the processor, based on the first one or more project records, a first default markup rate associated with the job category and the first location. The method may further include determining, by the processor, a second one or more project records associated with the job category and a second location. Each project record of the second one or more project records may indicate a workforce resource payment rate for worked performance in relation to the job category and the first location. The method may further include determining, by the processor, based on the first default markup rate and the second default markup rate, a third default markup rate associated with the job category and a third location.

In another example embodiment, an apparatus may include a processor and a memory including computer-executable instructions. The memory and the computer-executable instructions are configured to, with the processor, cause the apparatus to at least perform operations including determining a first one or more project records associated with a job category and a first location. Each project record of the first one or more project records indicates a workforce resource payment rate for worked performance in relation to the job category and the first location. The memory and computer-executable instructions are also configured to cause the apparatus to at least perform further operations of determining based on the first one or more project records, a first default markup rate associated with the job category and the first location. The memory and computer-executable instructions are also configured to cause the apparatus to at least perform further operations of determining a second one or more project records associated with the job category and a second location. Each project record of the second one or more project records may indicate a workforce resource payment rate for worked performance in relation to the job category and the first location. The memory and computer-executable instructions are also configured to cause the apparatus to at least perform further operations of determining based on the second one or more project records, a second default markup rate associated with the job category and the second location. The memory and computer-executable instructions are also configured to cause the apparatus to at least perform further operations of determining based on the first default markup rate and the second default markup rate, a third default markup rate associated with the job category and a third location.

In another example embodiment, a computer program product may include at least one computer-readable storage medium having computer-executable program code instructions stored therein. The computer-executable program code instructions may include program code instructions configured to determine a first one or more project records associated with a job category and a first location. Each project record of the first one or more project records may indicate a workforce resource payment rate for worked performance in relation to the job category and the first location. The computer program product may further include program code instructions configured to determine based on the first one or more project records, a first default markup rate associated with the job category and the first location. The computer program product may further include program code instructions configured to determine a second one or more project records associated with the job category and a second location. Each project record of the second one or more project records may indicate a workforce resource payment rate for worked performance in relation to the job category and the first location. The computer program product may further include program code instructions configured to determine based on the second one or more project records, a second default markup rate associated with the job category and the second location. The computer program product may further include program code instructions configured to determine based on the first default markup rate and the second default markup rate, a third default markup rate associated with the job category and a third location.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is a block diagram of a system;

FIG. 2 is a block diagram of a system;

FIG. 3A is a flow diagram of an exemplary method;

FIG. 3B is a flow diagram of another exemplary method; and

FIG. 4 is a block diagram illustrating an exemplary computing device.

### DETAILED DESCRIPTION

Some embodiments of the present disclosure will now be described more fully hereinafter with reference to the accompanying drawings, in which some, but not all embodiments of the present disclosure are shown. Indeed, various embodiments of the present disclosure may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments described herein.

A hiring party (also referred to as a “customer”) may need to supplement an existing work force. In order to supplemental the existing workforce, the customer may submit a workforce requisition for one or more candidates to a workforce supplier (also referred to as a “supplier”). However, the customer may be unfamiliar with current rates for workers for a given job category and/or locale (e.g., city, metropolitan area, state, etc.). Additionally, the customer may be unfamiliar with associated markups by the workforce supplier when presenting workers to the customer. A lack of clarity staffing rates and markups when obtaining workers may lead to cost overages and budgeting difficulty for the customer due to paying above market rate for a workforce resource. Moreover, when conducting negotiations to obtain a workforce resource using a computing device in which the customer and workforce supplier conduct negotiations over a network via an associated device, the lack of clarity may result in multiple rounds of negotiations facilitated by computing device between the customer and supplier, which may inefficiently consume processing capacity and memory capacity of the computing device. Applicant has identified that conserving processing resources and memory space are important to improving any implementation of a more efficient manner for performing workforce resource analysis. Because the exemplary embodiments enable a vendor management server (VMS) to provide a customer with default market rates and default markup rates associated with a submitted job category and/or location, a number of negotiations (e.g., electronic negotiations) performed by the VMS for market rates may be reduced, enabling the VMS to reduce consumption of processing resources, conserve memory space and minimize network traffic (e.g., conserve network bandwidth). As such, systems structured in accordance with various embodiments of the invention provide specific, technical solutions to technical problems faced by some systems. Accordingly, providing insight into workforce resource rates for particular job categories in a given market, as well as supplier markup rates, prior to entering negotiations to obtain workforce resources by the customer may be advantageous.

Systems, methods, and apparatuses are described for workforce resource analysis and workforce management. A method may comprise determining a generalized, “default” markup associated with a job category of a contemplated workforce requisition and/or a location associated with the contemplated workforce requisition. The default markup may comprise a monetary rate or amount that a supplier or intermediate party charges or retains for facilitating an engagement between a hiring party and a workforce resource party. Based on the default markup associated with a particular job category and/or location, a market rate associated with a job category and/or location may be determined. Based on hiring data associated with a particular hiring party, a historic rate for a job category and location indicated by the hiring party may be determined. The market rate may refer to the rate for the job category and/or location as a whole, without particular respect to the hiring party. The historic rate may refer to the rate for the hiring party's previous workforce resource engagements associated with that job category and/or location.

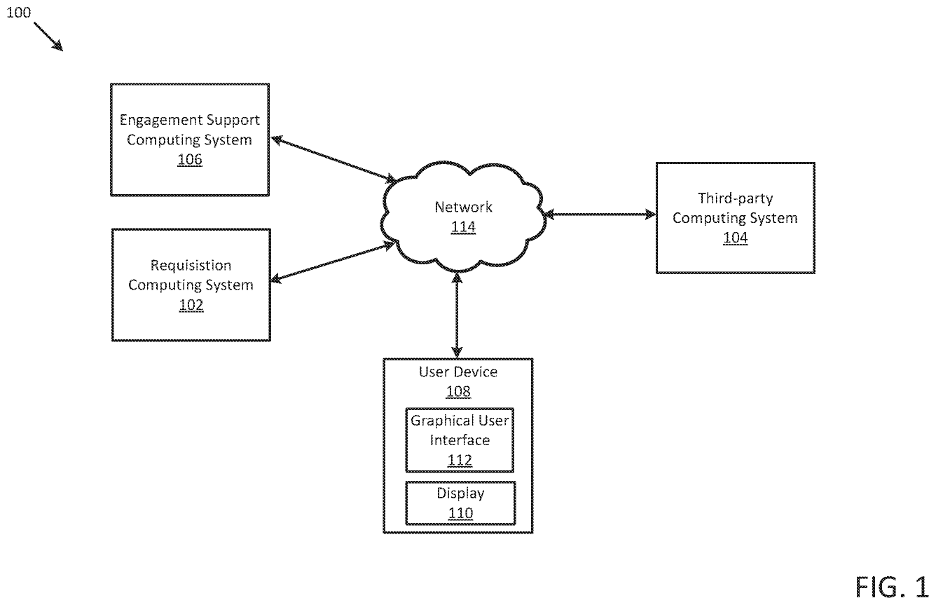

Referring to FIG. 1, a system 100 may comprise a requisition computing system 102, an engagement support computing system 106, and a third-party computing system 104. The system 100 may comprise a user device 108 configured with a display 110 to output a graphical user interface 112. The requisition computing system 102, the third-party computing system 104, the engagement support computing system 106, and the user device 108 may be in mutual communication via a network 114. The network 114 may comprise a wide area network (WAN), such as the Internet, a local area network (LAN), such as a wireless local area network (WLAN), or other types of networks.

The requisition computing system 102 may be associated with a hiring party. The engagement support computing system 106 may be associated with a support party that assists or facilitates the hiring party in realizing a workforce resource engagement or hire for the hiring party. The hiring party may have a business agreement with the support party and may make payment to the support party for such services. The support party may perform workforce resource management or consulting for the hiring party, for example. The support party may provide information relating to workforce resource requisition and engagement to the hiring party, such as supplier markup data, market rate data, and historic rate data, to assist the hiring party in determining a workforce resource to hire for fulfilling a workforce resource requisition.

The third-party computing system 104 may be associated with a party external to the hiring party. The third-party computing system 104 may be associated with another hiring party other than the aforementioned hiring party associated with the requisition computing system 102. The third-party computing system 104 may be associated with a party that collects and aggregates workforce resource data from various sources, such as various hiring parties. The requisition computing system 102 and the third-party computing system 104 may each store one or more project records associated with work performed by one or more workforce resources. The project records stored by the requisition computing system 102 may comprise project records associated with the hiring party, such as project records indicating workforce resource hiring undertaken by the hiring party. The project records stored by the third-party computing system 104 may comprise project records associated with other hiring parties, although such project records may also include project records associated with the hiring party. The third-party computing system may serve as an external source of workforce resource data for the hiring party.

The requisition computing system 102, the engagement support computing system 106, and the third-party computing system 104 each may comprise one or more computing devices, such as a server computing device, personal computing device, mainframe computing device, network device, and distributed computing environment. The requisition computing system 102, the engagement support computing system 106, and the third-party computing system 104 each may comprise a plurality of networked computing devices. As used herein, a “party” may refer to a person, a group of persons, a business entity, or other type of institution.

The user device 108 may be operated by a user that is associated with the hiring party, such as an employee of the hiring party. The user device 108 may comprise, for example, a personal computer, a laptop computer, or a mobile device. The user device 108 may comprise the display 110, which may be configured to output the graphical user interface 112. The graphical user interface 112 may be displayed as part of a webpage or a stand-alone application. The graphical user interface 112 and/or the underlying data for the graphical user interface 112 may be provided by (e.g., hosted by) the requisition computing system 102 and/or the engagement support computing system 106.

The graphical user interface 112 may include one or more elements by which a user may request information on workforce resource requisition, engagement, and hiring. The graphical user interface 112 may include one or more elements by which a user may input one or more job categories and/or locations for a job contemplated or undertaken by the hiring party. Based on the input of the one or more job categories and/or locations, the graphical user interface 112 may be caused to output an associated default supplier markup, market rate, and/or historic rate. Based on the input of the one or more job categories and/or locations, the graphical user interface 112 may be caused to output one or more suppliers and/or workforce resources, (e.g., a pre-determined number thereof). The one or more suppliers and/or resources caused to be output may be associated with the lowest supplier markups, the lowest workforce resource payment rates, or other most-favorable characteristics of suppliers and/or workforce resources.

The graphical user interface 112 may include one or more elements that enable the user to select a workforce resource, select a supplier associated with a workforce resource, and engage the selected resource, as examples. For example, a user may input a job category and a location and the graphical interface may be caused to output one or more elements that allow the user to select among one or more suppliers, one or more workforce resources, or one or more supplier/workforce resource combinations. The selected supplier, workforce resource, or supplier/workforce resource combination may be the party offering the conditions most favorable for the hiring party.

The graphical user interface 112 may be caused to output a supply ratio that indicates the ratio between the number of job openings associated with an open requisition of the hiring party and the number of candidate workforce resources that may fulfill the open requisition. The supply ratio may be associated with a job category, such as a job category that is input via the graphical user interface 112. A pre-determined number (e.g., three) of suppliers, workforce resources, or combinations thereof that are associated with the job category and the highest or most favorable supply ratios may be caused to be output (and selectable) via the graphical user interface 112. The supply ratio may be associated with a combination of a job category and a location, each of which may be input via the graphical user interface 112. A pre-determined number (e.g., three) of suppliers, workforce resources, or combinations thereof that are associated with the input location and job category and the highest or most favorable supply ratios may be caused to be output (and selectable) via the graphical user interface 112. A pre-determined number (e.g., three) of locations (e.g., metropolitan areas) that are associated with the highest or most favorable supply ratios may be caused to be output (and selectable) via the graphical user interface 112.

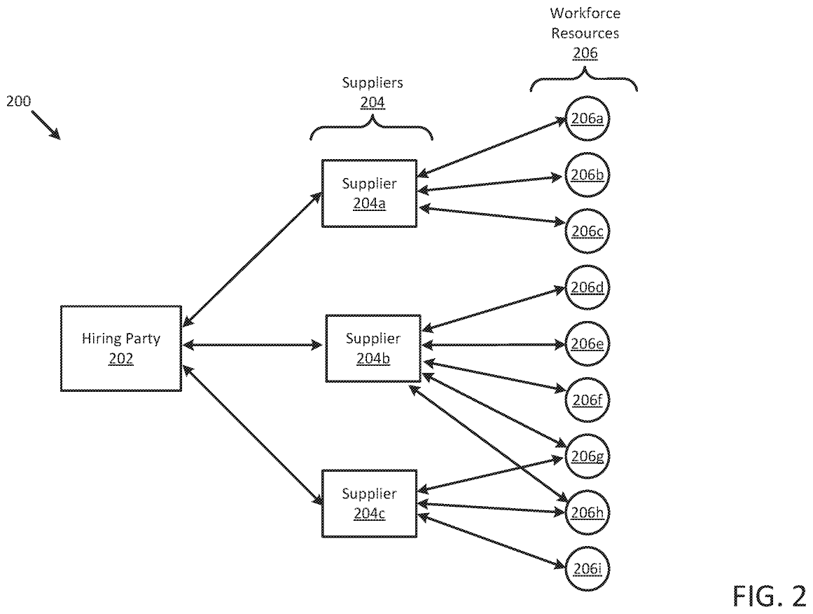

Referring to FIG. 2, a system 200 comprises a hiring party 202, a plurality of suppliers 204 (e.g., suppliers 204a-c), and a plurality of workforce resources 206 (e.g., workforce resources 206a-i). The hiring party 202 may be a party seeking to select and hire, or otherwise engage, a workforce resource 206 from the plurality of workforce resources 206. Each supplier 204 may be associated with one or more workforce resources 206 that are candidates for hire or are otherwise relevant to the hiring party's 202 job. Although not necessarily shown in FIG. 2, a supplier 204 may be associated with other workforce resources 206 that are not relevant to the hiring party's 202 requisition. The suppliers 204 may overlap in their associated workforce resources 206, such as the workforce resource 206g and the workforce resource 206h both being associated with the supplier 204b and the supplier 204c.

A supplier 204 may serve as an intermediary (e.g., an intermediate party, as variously referred to herein) between the hiring party 202 and the workforce resources 206 associated with the supplier 204. A supplier 204 may comprise a contracting agency, for example, in which one or more workforce resources 206 are employed by the contracting agency and the contracting agency assigns one or more of their employed workforce resources 206 to temporarily work for or with the hiring party 202. As another example, a supplier 204 may comprise a general contractor that is associated with or has relationships with one or more workforce resources 206, such as one or more carpenters, one or more masons, and one or more electricians.

A supplier 204 may promote one or more associated workforce resources 206 for hire in return for a percentage, or other measure, of the payment from the hiring party 202 for the hired workforce resource's 206 services or other benefits. A supplier 204 may indicate, such as to the hiring party 202, a rate or cost for an associated workforce resource 206 and/or the supplier's 204 markup. The hiring party 202 may poll one or more suppliers 204 to determine available workforce resources 206 in a particular job category and/or location. One or more workforce resources 206 may be hired via an associated supplier 204. Payment from the hiring party 202 to a workforce resource 206 may be made via an associated supplier 204.

The workforce resources 206, as well as the suppliers 204 additionally or alternatively, may be associated with a job category, such as a particular type of construction, service, or manufacturing. A job category may comprise a particular skill, technology, or an accreditation or certification relating to a skill or technology. A job category may comprise a full-time work schedule or a part-time work schedule. A job category may comprise a group of job categories. For example, a job category may comprise a job category group, with the job category group comprising multiple individual job categories or even further job category sub-groups. A job category may be defined by a hiring party 202 or a third-party. A job category may be defined according to a government agency, such as the United States Bureau of Labor Statistic's Standard Occupational Classification (SOC). A job category may be defined according to a classification or taxonomy provided by O*NET.

The workforce resources 206, as well as the suppliers 204 additionally or alternatively, may be associated with a location, such as a metropolitan area or a state in which the hiring party 202 operates or contemplates needing a contingent workforce resource. A metropolitan area may be defined according to a metropolitan statistical area. A location may comprise a postal code region. The workforce resources 206 may comprise an individual person, a group of persons, a business entity, or other sort of institution.

As an example, the hiring party 202 may hire one or more workforce resources 206 by opening a requisition indicating one or more openings that the hiring party 202 wants filled. The requisition may be provided to one or more suppliers 204. The requisition may serve as a prompt for one or more suppliers 204 to propose one or more candidate workforce resources 206 associated with the supplier 204 to fill the openings indicated in the requisition. If the one or more workforce resources 206 are thus hired, each workforce resource 206 may be associated with a “project” while within the scope of the requisition. A project may be uniquely associated with one workforce resource 206.

Work performed by a workforce resource 206 may be documented in an associated timesheet. A timesheet may be defined according to a time unit (e.g., a day) and indicate work performed, if any, for each of one or more time units represented in the timesheet. The work performed for a given time unit may be captured as a “project record.” In addition to indicating a particular time unit and the work performed during (or otherwise associated with) the time unit, a project record may indicate related data, such as the workforce resource 206, the project associated with the workforce resource 206, the job category, the location, the rate billed to the hiring party 202, and the rate paid to the workforce resource 206.

For example, a per-day timesheet for a particular workforce resource 206 may cover a week and indicate the hours worked, if any, for each day of the week. A project record may be created for each day worked and indicate the hours worked that day. If the example per-day timesheet indicates that the workforce resource 206 worked on Monday for 6 hours and Wednesday for 8 hours, two project records may be created. A first project record may indicate the 6 hours worked on Monday and a second project record may indicate the 8 hours worked on Wednesday. The first and second project records may be associated with the workforce resource's 206 associated project. Additional timesheets for the workforce resource 206 covering additional weeks may be also submitted. Thus, a workforce resource 206 and/or associated project may be associated with multiple timesheets and each of the multiple timesheets may be associated with multiple project records. By extension, a workforce resource 206 and/or associated project may be associated with multiple project records. Further, a requisition originated by the hiring party 202 may be associated with multiple project records.

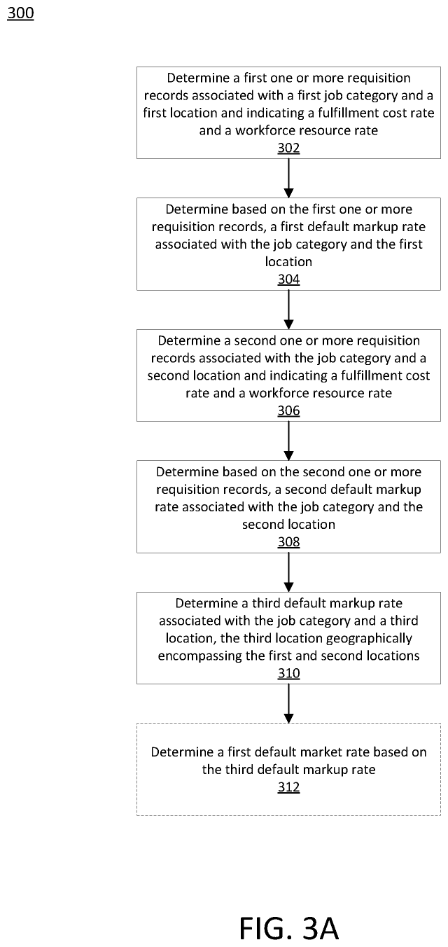

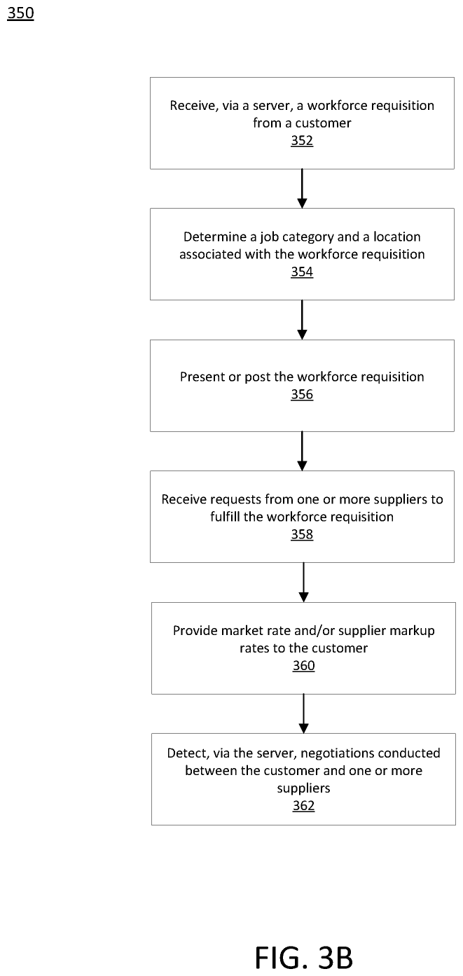

Referring to FIG. 3A, a method 300 may determine a first one or more project records (also referred to herein as requisition records) associated with a job category and a first location, at step 302. The engagement support computing system 106 of FIG. 1 may determine the first one or more project records, for example. Each of the first one or more project records may be associated with a workforce resource party, a project associated with the workforce resource party, and a timesheet associated with the project and/or workforce resource party. Each of the first one or more project records may comprise an associated timesheet. Each of the first one or more project records may be associated with a time entry of a timesheet. For example, a project record may indicate the hours worked by the workforce resource party on a particular day. Each of the first one or more project records may be further associated with a workforce requisition by a requesting party (e.g., a hiring party 202 of FIG. 2). Each of the first one or more project records may be associated with a workforce resource party.

The first one or more project records may be determined based on the job category and the first location. The job category and/or the first location may be provided by a user via a graphical user interface. The graphical user interface may be provided by the engagement support computing system 106 of FIG. 1 and viewable at the requisition computing system 102, for example. The graphical user interface may display the first one or more project records (individually or in any combination) and characteristics thereof.

Each of the first one or more project records may indicate one or more characteristics of an associated requisition, workforce resource party, project, or timesheet. Each of the first one or more project records may indicate the job category and the first location for the associated requisition, workforce resource party, project, or timesheet. A requisition, workforce resource party, project, or timesheet may be associated with additional job categories and/or additional locations and those may be also indicated in the corresponding project record. A location may refer to a city, a metropolitan area, or a state. A location may be defined according to a political boundary. A metropolitan area may be defined as a metropolitan statistical area. A location may be defined according to a postal code (i.e., the location comprises a postal code region).

Each of the first one or more project records may indicate the work performed by a workforce resource party (e.g., a workforce resource 206 of FIG. 2). Each of the first one or more project records may indicate that the work was or will be paid for by the requesting party and/or that the workforce resource party was or will be paid for the work. For example, a project record may indicate that a workforce resource party associated with the project record performed a job for the requesting party associated with the project record. Each of the first one or more project records may indicate a rate (“workforce resource payment rate”) at which an associated workforce resource party was paid for performing the work. That is, such a workforce resource payment rate may reflect the payment received by the workforce resource party for performing the work, which may not typically equal the amount paid by or bill to the requesting party. A rate (including a workforce resource payment rate, a workforce resource cost rate, or other rate) may comprise an hourly, per-item, per-task, or per-job rate or a flat amount, as examples. A rate may reflect a regular, non-overtime rate.

Each of the first one or more project records may indicate a rate (“workforce resource cost rate”) paid, as a whole, by the associated requesting party for work performed by the workforce resource party. For example, a project record may indicate a workforce resource payment rate paid to the workforce resource party in addition to any markup rate of an intermediate party. For example, a project record may indicate that a requesting party paid a total of $110.00 for work by a workforce resource party (the workforce resource cost rate), the workforce resource party received $100.00 (the workforce resource payment rate), and an intermediate party received or retained $10.00. The project record may indicate that the intermediate party had a markup rate of $10.00 or, additionally or alternatively, a 10% markup rate. A markup rate indicated in a project record may be specific to that project or may be a generalized markup rate for that intermediate party.

At step 304, a first default markup rate may be determined that is associated with the job category and first location. The first default markup rate may be collectively representative of a first one or more markup rates indicated by or determined based on the first one or more project records. For example, the first default markup rate may be determined by taking a median or mean of the first one or more markup rates. A markup rate of the first one or more markup rates may be determined based on characteristics of a corresponding project record of the first one or more project records, such as determining a ratio between a workforce resource cost rate and an associated workforce resource payment rate. A markup rate of the first one or more markup rates may indicate a markup rate of the intermediate party associated with the corresponding project record of the first one or more project records.

Determining the first default markup rate may comprise determining that the first one or more project records and/or the first one or more markup rates satisfy one or more criteria. If the first one or more project records do not satisfy a criteria, one or more parameters for determining or defining the first one or more project records may be altered. The one or more parameters may be altered so that the first one or more project records satisfies the one or more criteria.

An example criteria relates to the quantity of project records of the first one or more project records. The criteria may be satisfied if a quantity of project records of the first one or more project records exceeds or otherwise satisfies a threshold quantity of project records (e.g., 30 project records). As such, determining the first default markup rate may comprise determining that a quantity of project records of the first one or more project records satisfies the threshold quantity.

Another example criteria relates to the quantity of projects represented in the first one or more project records. Such a criteria may additionally or alternatively relate to the quantity of workforce resource parties represented in the first one or more project records. Determining the first default markup rate may comprise determining that the first one or more project records are, in aggregate, associated with a threshold quantity of projects or greater. Determining that the first one or more project records are associated with the threshold quantity of projects may comprise determining that at least X number of project records are, in aggregate, associated with Y number of projects. For example, the aforementioned criteria may be satisfied if at least 30 (X) project records of the first one or more project records are, in aggregate, associated with 5 (Y) or more projects. That is, at least 5 projects are to be represented, at least in part and in any combination, by at least 30 project records of the first one or more project records. Determining the first default markup rate may comprise determining that the first one or more project records are, in aggregate, associated with a threshold quantity of unique workforce resource parties or greater.

The quantity of project records of the first one or more project records and/or the quantity of projects represented in the first one or more projects records may be adjusted (e.g., increased) by altering (e.g., lengthening) the time period according to which the first one or more project records is determined. The time period for the first one or more project records may be defined as a prior length of time measured backwards from a marked date. The marked date may comprise, for example, a present date, a date on which the first one or more project records is determined, or a date on which the first one or more project records is evaluated in view of the noted criteria. An initial time period associated with the first one or more project records may be lengthened, such as by increasing the time period from 60 days prior to 180 days prior, from 60 days prior to 180 days prior, or from 180 days prior to 360 days prior.

Whether a particular project record is within a time period may be measured according to a date associated with the particular project record, such as the date that the project was opened, the date that the project began, the date that the project terminated, that date that the associated project record was closed, the date that the associated requesting party paid for the project, or the date that the workforce resource party was paid. This date may be indicated in a project record.

The quantity of project records of the first one or more project records and/or the quantity of projects represented in the first one or more project records may be adjusted (e.g., increased) by enlarging the region identified as the first location. For example, an initial first location may refer to a particular metropolitan area. The initial location may be redefined to refer to the state in which the metropolitan area is located.

The quantity of project records of the first one or more project records and/or the quantity of projects represented in the first one or more project records may be adjusted (e.g., increased) by redefining the job category so as to include a larger range of job types. For example, the job category may be redefined as a job category group that comprises the initial job category among several other different job categories.

The one or more parameters (e.g., the period of time and the region identified as the first location) may be altered over two or more iterations to affect an incremental adjustment of the one or more parameters, such as to avoid over-broadening the scope of the first one or more project records. As such, determining the first default markup rate may comprise multiple iterations of evaluating the first one or more project records and adjusting the one or more parameters accordingly. Such iterations may continue until the resulting one or more project records satisfies the one or more criteria. The updated first one or more project records may be considered a further iteration of the first one or more project records or may be considered another, different set of one or more project records, such as a third one or more project records. By using the iterative approach described above to refine the set of project records through the use of criteria and adjustable parameters, the exemplary embodiments may provide improved accuracy/efficiency of processing the set of project records by avoiding, or minimizing, the over-broadening of the result set. By minimizing the over-broadening of the result set, the exemplary embodiments may conserve processing capacity of computing devices and may conserve memory space of memory devices. In some example embodiments, the iterative approach may be performed automatically (i.e., automated) by a computing device (e.g., requisition computing system 102). In some other example embodiments, the iterative approach may be adjustable based in part on user input detected via a user interface (e.g., graphical user interface 112).

At step 306, a second one or more project records associated with the job category and a second location may be determined. The second one or more project records may be similar in some respects to the first one or more project records. The second one or more project records may be determined based on the job category and the second location. The job category and/or the second location may be input by a user via a graphical user interface. The graphical user interface may display the second one or more project records (individually or in any combination) and characteristics thereof. Each of the second one or more project records may indicate the job category and the second location for the associated project, for example.

Each project record of the second one or more project records may indicate an associated requesting party, intermediate party, and workforce resource party. Each project record of the second one or more project records may indicate an associated workforce resource payment rate for the workforce resource party and an associated workforce resource cost rate paid by the requesting party for the work performed by the workforce resource party. A markup rate may be determined for each project record of the second one or more project records based on the workforce resource payment rate and workforce resource cost rate associated with the project record.

At step 308, a second default markup rate, associated with the job category and the second location, may be determined based on the second one or more project records. The second default markup rate may be determined based on workforce resource cost rates and corresponding workforce resource payment rates indicated by associated project records of the second one or more project records. The second default markup rate may be collectively representative of a second one or more markup rates associated with the job category and second location. A markup rate of the second one or more markup rates may be indicated in the corresponding project record of the second one or more project records and indicative of a markup by the intermediate party associated with the corresponding project record of the second one or more project records. Additionally or alternatively, the second one or more markup rates may be determined based on the second one or more project records. The second default markup rate may be collectively representative (e.g. a median or mean) of the second one or more markup rates associated with the second one or more project records.

Determining the second default markup rate may comprise determining that the second one or more project records satisfy one or more criteria. If the second one or more project records do not satisfy a criteria, one or more parameters for determining or defining the second one or more project records may be adjusted. For example, determining the second default markup rate may comprise determining that a quantity of project records of the second one or more project records exceeds or otherwise satisfies a threshold quantity of project records. As another example, determining the second default markup rate may comprise determining that a quantity of projects represented in the second one or more project records exceeds or otherwise satisfies a threshold quantity of projects.

If one or more criteria are not met, the second one or more project records may be expanded or otherwise altered by increasing the period of time according to which the second one or more project records is determined or defined. Additionally or alternatively, the region identified as the second location may be enlarged to increase or otherwise alter the quantity of project records of the second one or more project records and/or the quantity of projects represented in the second one or more project records. Additionally or alternatively, the job category may be adjusted, such as to encompass a larger variety of job types. For example, the job category may be adjusted by redefining the job category to a larger job category group within which the initial job category is a part. The expanded or otherwise altered second one or more project records may be re-evaluated against the one or more criteria. If the one or more criteria are not satisfied, the one or more parameters for determining or defining the second one or more project records may be further adjusted one or more times until the resulting iteration of one or more project records satisfies the one or more criteria.

At step 310, a third default markup rate associated with the job category and a third location may be determined based on the first default markup rate and the second default markup rate. The third location may geographically encompass, at least in part, the first location and the second location. For example, the first location may comprise a first metropolitan area and the second location may comprise a second metropolitan area. The third location may comprise a state in which the first and second metropolitan areas are located. The third default markup rate may be used as a state default markup rate for the job category. The third default markup rate may be used to determine a market rate associated with the job category when no location is indicated that is within the third location. For example, the third default markup rate may be used to determine a default market rate when the third location comprises a state and no postal code or metropolitan area are provided.

The third default markup rate may be, collectively, representative of the first default markup rate and the second default markup rate. For example, the third default markup rate may comprise a median or mean markup rate of at least the first default markup rate and the second default markup rate.

Optionally, at step 312, the third default markup rate may be used to determine a first default market rate associated with the job category. That is, the first default market rate associated with the job category may be determined based on the third default markup rate. The first default market rate may reflect, at least in part, a rate (e.g., cost) for hiring, by a requesting (hiring) party, via an intermediate party, a workforce resource party to fulfill a requisition in the associated job category and in the third location (e.g., the state, at large). The rate reflected, at least in part, in the first default market rate may be an estimated rate. The first default market rate may comprise a rate to be paid to a workforce resource party for work performed plus a markup rate to be paid to an intermediate party associated with the transaction. The aforementioned requesting party, intermediate party, and workforce resource party referred to with respect to the default market rate are used in the general sense rather than referring to a specific requesting party, intermediate party, or workforce resource party.

The first default market rate may be further based on a first one or more workforce resource payment rates associated with the third location and the job category. The first one or more workforce resource payment rates may indicate a rate for performing work in the third location and associated with the job category. The first one or more workforce resource payment rates may not reflect any markup rate that may be imposed by an intermediate party in hiring a workforce resource party. Thus, the first one or more workforce resource payment rates may indicate a rate that would be directly charged by a workforce resource party without any markup from an intermediate party. The first one or more workforce resource payment rates may be based on past rates charged by various workforce resource parties in the third location and in association with the job category. The first one or more workforce resource payment rates may be expressed in the form of percentile values. For example, the first one or more workforce resource payment rates may comprise a 25th percentile value for the first one or more workforce resource payment rates, a 50th percentile value for the first one or more workforce resource payment rates, and a 75th percentile value for the first one or more workforce resource payment rates. The first default market rate may be determined by applying the third default markup rate to the first one or more workforce resource payment rates.

A second default market rate associated with the first location and the job category may be determined based on the first default markup rate, which is likewise associated with the first location and the job category. The second default market rate may be associated with the first location and the first location may be geographically encompassed by the third location. The second default market rate may apply to a smaller and more specific location than the first default market rate. As an example, the first location may comprise a metropolitan area and the third location may comprise a state. The second default market rate may reflect a rate (e.g., cost) for hiring, by a requesting (hiring) party and via an intermediate party, a workforce resource party to perform work in the first location and associated with the job category. The second default market rate may be an estimate market rate. The second default market rate may include both a rate received by the workforce resource party and a rate received by the associated intermediate party.

The second default market rate may be further based on a second one or more workforce resource payment rates associated with the first location and the job category. The second one or more workforce resource payment rates may be similar in some respects with the first one or more workforce resource payment rates, but the second one or more workforce resource payment rates may be associated with the first location and the first one or more workforce resource payment rates may be associated with the third location. The one or more workforce resource payment rates may refer to a rate received by workforce resource party for performing work associated with the job category and in the first location. The one or more workforce resource payment rates may exclude a markup rate imposed by an intermediate party. The second default market rate may be determined by applying the first default markup rate to the second one or more workforce resource payment rates.

The first one or more workforce resource payment rates and/or the second one or more workforce resource payment rates may be received from an external source. Additionally or alternatively, the first one or more workforce resource payment rates and/or the second one or more workforce resource payment rates may be determined based on data from an external source. The external source may be associated with a government agency, such as a state or federal government agency. Conversely, the first default markup rate, the second default markup rate, and/or the third default markup rate may be determined based on data from an internal source. The internal source may be associated with a party that determines the first default markup rate, the second default markup rate, and/or the third default markup rate. The internal source may be associated with a party that provides (e.g., hosts) a graphical user interface (e.g., the graphical user interface 112 of FIG. 1) configured to output a default market rate and associated data. A user of the user device 108 of FIG. 1 may be associated with an internal source or a party providing the internal source. For example, the first one or more workforce resource payment rates and/or the second one or more workforce resource payment rates may be received from and/or based on data from the third-party computing system 104 of FIG. 1 and the first default markup rate, the second default markup rate, and/or the third default markup rate may be determined based on data from one or more of the engagement support computing system 106 and the requisition computing system 102. Additionally or alternatively, the first default markup rate, the second default markup rate, and/or the third default markup rate may be determined by one or more of the engagement support computing system 106 and the requisition computing system 102.

A graphical user interface (e.g., the graphical user interface 112 of FIG. 1) may be output for interaction with a user. The graphical user interface may be associated with requisition fulfillment and configured to display one or more default market rates according to various criteria and/or inputs, such as a job category and a location for the requisition. The one or more market rates may be displayed according to externally-received workforce resource payment rates.

The graphical user interface may be configured to receive, in association with a requisition, a job category input, a first location input, and a second location input.

In an aspect, the user may provide the job category input indicating the job category of the requisition. The job category input may be a required input to determine and display a default market rate. The user may provide the first location input indicating the third location, which geographically encompasses the first location and the second location. The first location input may indicate a state, for example. The first location input may be a required input. The user may provide the second location input indicating the first location (or other location geographically encompassed by the third location). The first location may comprise a postal code region or a metropolitan area, for example. Based on the input of the job category, the third location, and the first location, the second default market rate associated with the first location and the job category may be determined. as described above. The second default market rate may be determined further based on the second one or more workforce resource payment rates, which may be received from an external source or based on data received from an external source. The graphical user interface may display the second default market rate.

In an aspect, the user may provide the job category input indicating the job category of the requisition. The job category input may be a required input to determine and display a default market rate. The user may provide the first location input indicating the third location, which geographically encompasses the first location and the second location. The first location input may be designated for state, for example. The first location input may be a required input. The user may omit providing the second location input. For example, the user may leave a field in the graphical user interface designated for the second location input blank. The second location input may be designated for a postal code input or a metropolitan area input. Based on the job category input indicating the job category, the first location input indicating the third location, and the lack of input for the second location input, the first default market rate associated with the job category may be determined. The first default market rate may be determined further based on the first one or more workforce resource payment rates, which may be received from an external source or based on data received from an external source. The graphical user interface may display the first default market rate.

FIG. 3B is a flowchart of an example method 350 for negotiating a workforce requisition according to one or more exemplary embodiments. At block 352, a server (e.g., a vendor management server (VMS), e.g., requisition computing system 102) may receive, from a computing device of a customer (e.g., a hiring party), a requisition for a workforce resource to hire. At block 354, the server may determine a job category and/or location associated with the workforce requisition. At block 356, the server may present (or post) the workforce requisition to a graphical user interface to solicit responses from a computing device of one or more suppliers (e.g., a contingent workforce suppliers). At block 358, the server may receive a response to the workforce requisition from a computing device of one or more suppliers. At block 360, the server may determine and provide a market rate to the customer. The server may also provide supplier specific default markup rates based on the responses associated with the one or more suppliers and/or a default markup rate associated with the location (e.g., city, state, metropolitan area, etc.) associated with the workforce requisition. At block 362, the server may detect negotiations (e.g., electronic negotiations) conducted between the customer and one or more suppliers. The negotiations may be conducted via a graphical user interface presented by the server. Because the server (e.g., the VMS) has provided the customer with default market rates and default markup rates associated with a submitted job category and/or location, a number of negotiations (e.g., electronic negotiations) performed by the server for market rates may be reduced, enabling the server to reduce consumption of processing resources, conserve memory space and minimize network traffic (e.g., conserve network bandwidth).

Accordingly, methods, apparatuses and systems disclosed herein may enable customers to submit a requisition to staffing suppliers for contingent workforce assistance through a vendor management server and receive responses from the staffing suppliers, via the VMS. The responses may indicate one or more candidates having associated skills or an associated job category that may fulfill the requisition, along with a market rate for each submitted candidate. The customer may be provided with candidate market rate information, via the VMS, based on skills, job category, location and/or based on stored or third-party data related to rates that are being paid to workers for associated job categories and/or particular metropolitan statistical areas (MSAs). The VMS may additionally add a supplier markup to rates that are being paid to workers, which may be calculated from historical data stored in a VMS database and which may be used to adjust a stored market rate or market rate obtained from a third-party to determine a market rate (e.g., a billing rate for workers that are performing the same job listed in the requisition that are located within the MSA) for a job category in a particular location.

Accordingly, a customer may compare market rates received from staffing suppliers to a determined market rate (e.g., determined via the VMS) to obtain a market insight into market rates being paid by other employers for contingent workforce resources that are performing the same job in the same geographic area. The customer may use this insight to negotiate favorable market rates with staffing suppliers when obtaining contingent workforce resources. Accordingly, the exemplary methods, apparatuses and systems disclosed herein may enable a customer to minimize or avoid overpayment for contingent workforce resources and thereby better control financial resources.

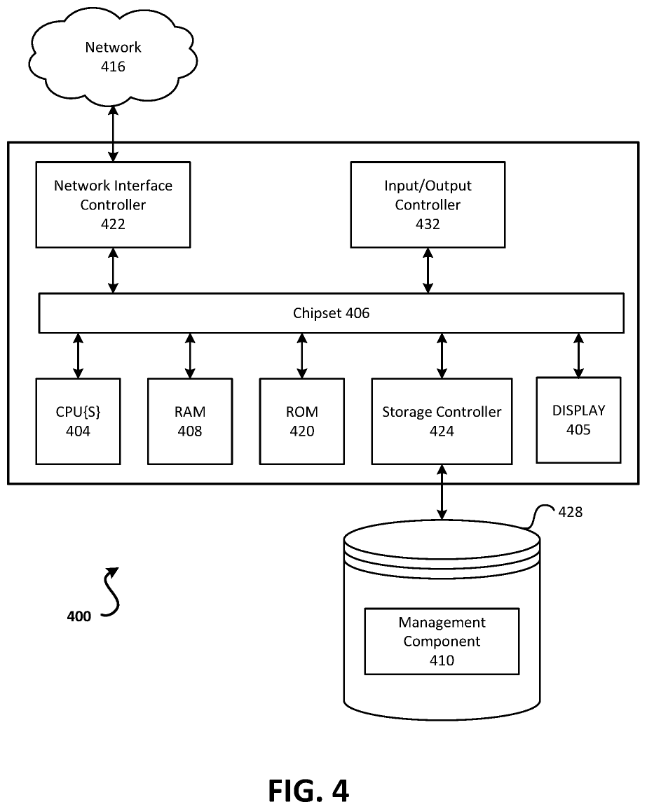

FIG. 4 depicts a computing device that may be used in various aspects, such as the servers, modules, and/or devices depicted in FIG. 1 and FIG. 2. With regard to the example architecture of FIG. 1, the electronic devices 102, 104, 106, and 108 may each be implemented in an instance of a computing device 400 of FIG. 4. The computer architecture shown in FIG. 4 may illustrate a server (e.g., server computer), workstation, desktop computer, laptop, tablet, network appliance, PDA, e-reader, digital cellular phone, or other computing node, and may be utilized to execute any aspects of the computers described herein, such as to implement the methods described herein.

The computing device 400 may include a baseboard, or “motherboard,” which is a printed circuit board to which a multitude of components or devices may be connected by way of a system bus or other electrical communication paths. One or more central processing units (CPUs) 404 may operate in conjunction with a chipset 406. The CPU(s) 404 may be standard programmable processors that perform arithmetic and logical operations necessary for the operation of the computing device 400.

The CPU(s) 404 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 404 may be augmented with or replaced by other processing units, such as graphics processing unit (GPU(s)) 205. The GPU(s) 405 may comprise processing units specialized for but not necessarily limited to highly parallel computations, such as graphics and other visualization-related processing.

A chipset 406 may provide an interface between the CPU(s) 404 and the remainder of the components and devices on the baseboard. The chipset 406 may provide an interface to a random-access memory (RAM) 408 used as the main memory in the computing device 400. The chipset 406 may further provide an interface to a computer-readable storage medium, such as a read-only memory (ROM) 420 or non-volatile RAM (NVRAM) (not shown), for storing basic routines that may help to start up the computing device 400 and to transfer information between the various components and devices. ROM 420 or NVRAM may also store other software components necessary for the operation of the computing device 400 in accordance with the aspects described herein.

The computing device 400 may operate in a networked environment using logical connections to remote computing nodes and computer systems through local area network (LAN) 416. The chipset 406 may include functionality for providing network connectivity through a network interface controller (NIC) 422, such as a gigabit Ethernet adapter. A NIC 422 may be capable of connecting the computing device 400 to other computing nodes over a network 416. It should be appreciated that multiple NICs 422 may be present in the computing device 400, connecting the computing device to other types of networks and remote computer systems.

The computing device 400 may be connected to a mass storage device 428 that provides non-volatile storage for the computer. The mass storage device 428 may store system programs, application programs, other program modules, and data, which have been described in greater detail herein. The mass storage device 428 may be connected to the computing device 400 through a storage controller 424 connected to the chipset 406. The mass storage device 428 may consist of one or more physical storage units. A storage controller 424 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 400 may store data on a mass storage device 428 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 428 is characterized as primary or secondary storage and the like.

For example, the computing device 400 may store information to the mass storage device 428 by issuing instructions through a storage controller 424 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 400 may further read information from the mass storage device 428 by detecting the physical states or characteristics of one or more particular locations within the physical storage units.

In addition to the mass storage device 428 described above, the computing device 400 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 400.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 428 depicted in FIG. 4, may store an operating system utilized to control the operation of the computing device 400. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 428 may store other system or application programs and data utilized by the computing device 400.

The mass storage device 428 or other computer-readable storage media may also be encoded with computer-executable instructions, which, when loaded into the computing device 400, transforms the computing device from a general-purpose computing system into a special-purpose computer capable of implementing the aspects described herein. These computer-executable instructions transform the computing device 400 by specifying how the CPU(s) 404 transition between states, as described above. The computing device 400 may have access to computer-readable storage media storing computer-executable instructions, which, when executed by the computing device 400, may perform methods described herein.

A computing device, such as the computing device 400 depicted in FIG. 4, may also include an input/output controller 432 for receiving and processing input from a number of input devices, such as a keyboard, a mouse, a touchpad, a touch screen, an electronic stylus, or other type of input device. Similarly, an input/output controller 432 may provide output to a display 405, such as a computer monitor, a flat-panel display, a digital projector, a printer, a plotter, or other type of output device. It will be appreciated that the computing device 400 may not include all of the components shown in FIG. 4, may include other components that are not explicitly shown in FIG. 4, or may utilize an architecture completely different than that shown in FIG. 4.

As described herein, a computing device may be a physical computing device, such as the computing device 400 of FIG. 4. A computing node may also include a virtual machine host process and one or more virtual machine instances. Computer-executable instructions may be executed by the physical hardware of a computing device indirectly through interpretation and/or execution of instructions stored and executed in the context of a virtual machine.

What is claimed is:

1. A method comprising:
determining, by a processor, a first one or more project records associated with a job category and a first location, wherein each project record of the first one or more project records indicates a workforce resource payment rate for worked performance in relation to the job category and the first location;
determining, by the processor, based on the first one or more project records, a first default markup rate associated with the job category and the first location;
determining, by the processor, a second one or more project records associated with the job category and a second location wherein each project record of the second one or more project records indicates a workforce resource payment rate for worked performance in relation to the job category and the first location;
determining, by the processor, based on the second one or more project records, a second default markup rate associated with the job category and the second location; and
determining, by the processor, based on the first default markup rate and the second default markup rate, a third default markup rate associated with the job category and a third location.

2. The method of claim 1, further comprising:
determining, by the processor, based on the third default markup rate, a first default market rate associated with the job category;
receiving, by the processor from a server, a requisition for one or more openings associated with the job category and a location in a predetermined area associated with the first location, the second location and the third location; and
transmitting, by the processor to the server, the third default markup rate and the first default market rate.

3. The method of claim 2, further comprising:
determining, based on the first one or more project records, a first one or more markup rates associated with the job category and the first location, wherein a markup rate of the first one or more markup rates is associated with a corresponding project record of the first one or more project records and indicates a markup by an intermediate party associated with the corresponding project record of the first one or more project records,
wherein the first default markup rate is further based on the first one or more markup rates.

4. The method of claim 1, further comprising:
determining, based on the second one or more project records, a second one or more markup rates associated with the job category and the second location, wherein a markup rate of the second one or more markup rates is associated with a corresponding project record of the second one or more project records and indicates a markup by an intermediate party associated with a corresponding project record of the second one or more project records,
wherein the second default markup rate is further based on the second one or more markup rates.

5. The method of claim 1, wherein at least one of the first location and the second location comprises a region associated with a metropolitan area.

6. The method of claim 1, wherein at least one of the first location and the second location comprises a postal code region.

7. The method of claim 1, wherein the third location comprises a state.

8. The method of claim 1, wherein the third default markup rate comprises a median markup rate of at least the first default markup rate and the second default markup rate.

9. The method of claim 2, further comprising:
receiving one or more workforce resource payment rates associated with the third location and the job category, wherein the first default market rate associated with the job category is further based on the one or more workforce resource payment rates associated with the third location and the job category.

10. The method of claim 1, further comprising:
determining, based on the first default markup rate, a second default market rate associated with the first location and the job category.

11. The method of claim 10, further comprising:
receiving one or more workforce resource payment rates associated with the first location and the job category, wherein the second default market rate associated with the first location and the job category is based on the one or more workforce resource payment rates associated with the first location and the job category.

12. The method of claim 11, further comprising:
displaying, via a graphical user interface, the second default market rate associated with the first location and the job category.

13. The method of claim 1, further comprising:
determining that a quantity of project records of the first one or more project records satisfies a threshold quantity of project records.

14. The method of claim 13, wherein one or more projects are each associated with at least one project record of the first one or more project records, the method further comprising:
determining that a quantity of the one or more projects satisfies a threshold quantity of projects.

15. The method of claim 1, further comprising:
for each project record of the first one or more project records, determining that a date associated with the project record is within a period of time associated with the first one or more project records.

16. The method of claim 1, wherein the first default markup rate indicates a relationship between a workforce resource cost rate and an associated workforce resource payment rate.

17. The method of claim 16, wherein the first default markup rate indicates a ratio between the workforce resource cost rate and the associated workforce resource payment rate.

18. The method of claim 1, further comprising:
determining, based on at least one project record of the first one or more project records that is associated with a user party, a historic workforce resource cost rate associated with the user party.

19. The method of claim 18, further comprising:
displaying, via a graphical user interface, the historic workforce resource cost rate associated with the user party.

20. The method of claim 1, further comprising:
determining that a quantity of project records of the first one or more project records does not satisfy a threshold quantity of project records.

21. The method of claim 20, further comprising:
determining a third one or more project records associated with the job category and the first location, wherein each project record of the third one or more project records is associated with a workforce requisition requested by a requesting party, facilitated by an intermediate party, and performed by a workforce resource party, and wherein each project record of the third one or more project records indicates a workforce resource payment rate according to which the workforce resource party was paid for performing work associated with the workforce requisition and a workforce resource cost rate according to which the requesting party paid for work performed by the workforce resource party,
wherein a quantity of project records of the third one or more project records is greater than the quantity of project records of the first one or more project records.

22. The method of claim 1, further comprising:
receiving, by the processor, a response to the requisition sent by one or more suppliers; and
transmitting, to a first computing device, a supplier specific markup rate for each of the one or more suppliers.

23. The method of claim 1, further comprising:
detecting one or more negotiations between a first computing device of a customer and a second computing device of at least one supplier in response to the requisition.

24. The method of claim 1, wherein the first one or more project records are associated with a plurality of parameters.

25. The method of claim 24 further comprising:
incrementally adjusting, by the processor, one or more of the plurality of parameters to decrease a quantity of the first one or more project records.

26. The method of claim 25, wherein the incremental adjustment is performed over at least two iterations.

27. An apparatus comprising:
a processor; and
a memory coupled with the processor, the memory comprising executable instructions stored thereon that when executed by the processor cause the apparatus to:
determine a first one or more project records associated with a job category and a first location, wherein each project record of the first one or more project records indicates a workforce resource payment rate for worked performance in relation to the job category and the first location;
determine based on the first one or more project records, a first default markup rate associated with the job category and the first location;
determine a second one or more project records associated with the job category and a second location wherein each project record of the second one or more project records indicates a workforce resource payment rate for worked performance in relation to the job category and the first location;
determine based on the second one or more project records, a second default markup rate associated with the job category and the second location; and
determine based on the first default markup rate and the second default markup rate, a third default markup rate associated with the job category and a third location.

28. The apparatus of claim 27, wherein when the processor further executes the instructions, the processor further causes the apparatus to:
determine based on the third default markup rate, a first default market rate associated with the job category;
receive, from a server, a requisition for one or more openings associated with the job category and a location in a predetermined area associated with the first location, the second location and the third location; and
transmit, to the server, the third default markup rate and the first default market rate.

29. The apparatus of claim 27, wherein when the processor further executes the instructions, the processor further causes the apparatus to:
detect one or more negotiations between a first computing device of a customer and a second computing device of at least one supplier in response to the requisition.

30. A computer readable storage medium storing computer executable instructions that when executed by a computing device cause the computing device to effectuate operations comprising:
determining a first one or more project records associated with a job category and a first location, wherein each project record of the first one or more project records indicates a workforce resource payment rate for worked performance in relation to the job category and the first location;
determining based on the first one or more project records, a first default markup rate associated with the job category and the first location;
determining a second one or more project records associated with the job category and a second location, wherein each project record of the second one or more project records indicates a workforce resource payment rate for worked performance in relation to the job category and the first location;
determining based on the second one or more project records, a second default markup rate associated with the job category and the second location; and
determining based on the first default markup rate and the second default markup rate, a third default markup rate associated with the job category and a third location.

31. The computer readable storage medium of claim 30, further comprising:
determining based on the third default markup rate, a first default market rate associated with the job category;
receiving, from a server, a requisition for one or more openings associated with the job category and a location in a predetermined area associated with the first location, the second location and the third location; and
transmitting, to the server, the third default markup rate and the first default market rate.

32. The computer readable storage medium of claim 30, further comprising:
detecting one or more negotiations between a first computing device of a customer and a second computing device of at least one supplier in response to the requisition.
